(19) United States
(12) Patent Application Publication
(10) Pub. No.: US 2024/0105181 A1
(43) Pub. Date: Mar. 28, 2024

(54) METHODS, SYSTEMS, AND APPARATUS FOR AUTOMATON NETWORKS HAVING MULTIPLE VOICE AGENTS FOR SPEECH RECOGNITION

(71) Applicant: Snap One, LLC

(72) Inventors: John Major, Salt Lake City, UT (US); Erik Douglas Frederick, Durham, NC (US); Matthew Wilden, Riverton, UT (US); D.Craig Conder, Sandy, UT (US)

(73) Assignee: Snap One, LLC, Lehi, UT (US)

(21) Appl. No.: 18/373,859

(22) Filed: Sep. 27, 2023

Related U.S. Application Data
(60) Provisional application No. 63/410,286, filed on Sep. 27, 2022.

(51) Int. Cl. G10L 15/32; G10L 15/22; G10L 15/30

(52) U.S. Cl. CPC G10L 15/32; G10L 15/22; G10L 15/30

(57) ABSTRACT

A whole home voice (WHV) system of an automation network is described. The WHV system may be of and/or for an automation network connecting an automation server, an automation controller, and any number of automation devices. The WHV system includes any number of voice input devices for receiving voice inputs vocalized by a user of the automation network; and an automation controller for executing any of: (1) a voice coordinator for coordinating WHV system operations, (2) any number of voice input proxies for proxying for the voice input devices; and (2) a voice daemon executing any number of voice daemon instances each respectively associated with one of any number of voice targets, wherein the automation controller is communicatively connected to the voice targets.

### TECHNICAL FIELD

The present disclosure relates generally to electrical devices included in electronic device communication networks, such as home networks, office networks, business networks, etc. For example, the present disclosure relates to any of apparatuses, systems, and methods for controlling, configuring, and/or operating electrical devices.

### BACKGROUND

Environments including electronic devices connected to and/or operating via networks include many of the commonly used electronic devices, such as phones, computers, audio/video (e.g., control, distribution, etc.) devices, speakers, microphones, televisions, video displays, digital displays, lighting, dimmers, kitchen appliances, thermostats, Heating Venting and Air Conditioning (HVAC) equipment, water heaters and pumps, plumbing equipment, windows, window coverings, doors, locks, garages, security systems, video surveillance systems, sensor devices, networking equipment, etc.

In a variety of environments, such as homes, gardens, offices, businesses, public spaces, etc., many of such electronic devices are connected to an automation network, for example, allowing for a user to control and automate operation of a plurality of electronic devices. Control and operation of an automation network may be provided by graphical user interface (GUI) and/or user input devices, for example, tablet or computer displaying a GUI and/or a remote for having (e.g., physical and/or virtual) buttons for user input. In many of such environments, virtual assistant services employing software and/or hardware for voice recognition services and/or virtual assistant services are prevalent technologies for electronic device control and operation. For example, a variety of (e.g., branded, proprietary, etc.) voice assistant services are available to customers. However, many of the branded and/or proprietary services have closed (e.g., respective, restricted, stand-alone, etc.) ecosystems consisting of proprietary and compatible and/or approved third-party hardware and software. Additionally, in some cases, voice assistant services are linked to a singular device and/or singular user service.

For electronic devices, such as those included in an automation network, voice assistant software, also referred to as a voice agent and/or voice agent software, provides voice command and control capabilities, for example, providing a user any of configuration and/or operation of the electronic devices. For example, a conventional home speaker can include a microphone for providing voice input and a processor executing software, such as a voice agent, for voice recognition and/or processing, and can be used to control the electronic devices for which the voice agent is configured. Further, a microphone, or more generally a voice input device (e.g., any electronic device capable of sensing a user's speech, sounds, voice, etc.).

### BRIEF DESCRIPTION OF THE DRAWINGS

FIG. 1 is a diagram illustrating an example automation network, according to embodiments;

FIG. 2 is a diagram illustrating components and architecture of a WHV system, according to embodiments;

FIG. 3 is a diagram illustrating a signal flow for whole home voice (WHV) services, according to embodiments; and

FIG. 4 is a diagram illustrating voice target registration for whole home voice (WHV) services, according to embodiments.

### DETAILED DESCRIPTION

### Exemplary Automation Network

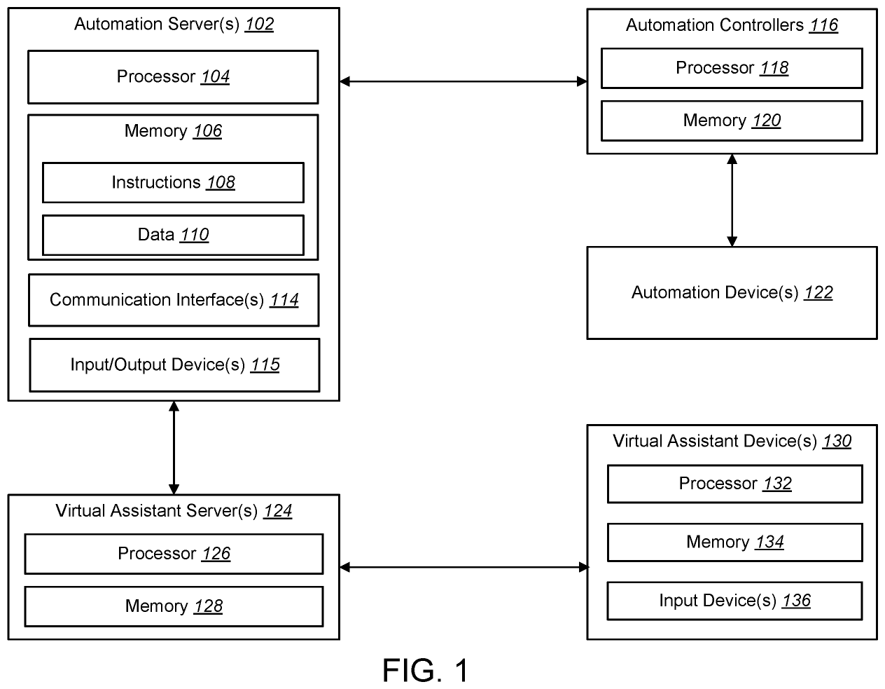

FIG. 1 is a diagram illustrating an example automation network, for example, for implementing any of the disclosed embodiments. According to embodiments, a (e.g., home, office, etc.) network environment having automation control features, services, operations, devices, software, hardware, etc., may provide a communication system for command and control of electronic devices associated with voice assistant (which may be interchangeably referred to as a voice agent) features, operations, systems, services, elements, devices, software, hardware, etc.

According to embodiments, for example, referring to FIG. 1, an automation network may include any number of any of: automation server(s) 102, automation controller(s) 116, automation device(s) 122, virtual assistant (e.g., voice agent) server(s) 124, virtual assistant (e.g., voice agent) device(s) 130, and any other similar and/or suitable devices that may be included in a network environment. According to embodiment, there may be a case where one or more virtual assistant (e.g., voice agent, voice target) server(s) 124 and one or more virtual assistant (e.g., voice agent, voice target) device(s) 130 may be collocated, for example, as one device, as a single entity, as a single (e.g., addressed) end-point, etc. For example in such a case of a virtual assistant server 124 and a virtual assistant device 130 being collocated, respective processors 126, 132 and respective memory 128, 134 may be (e.g., also) collocated and/or combined.

According to embodiments, for example, referring to FIG. 1, an automation network, and/or any of the devices, elements, components, services, features, etc., of an automation network, may provide (e.g., be for providing, be configured for, etc.) whole home voice (WHV) services as discussed hereinbelow. Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods. As used herein, the term “plurality” may indicate two or more. For example, a plurality of components may refer to two or more components.

According to embodiments, for example, referring to FIG. 1, there may be one or more automation servers 102 in which systems and methods for WHV services may be implemented. An automation server 102 is an electronic device that is configured to communicate with one or more automation controllers 116 and/or one or more automation devices 122. For example, an automation server 102 may send automation data to one or more automation controllers 116 and/or one or more automation devices 122. Additionally or alternatively, the automation server 102 may receive automation data from one or more automation controllers 116 and/or one or more automation devices 122. As used herein, an “automation server” may refer to one or more automation servers.

The automation server 102 may include one or more components or elements. One or more of the components or elements may be implemented in hardware (e.g., circuitry), a combination of hardware and software (e.g., a processor with instructions), and/or a combination of hardware and firmware. According to embodiments, the automation server 102 may include any of: a processor 104, a memory 106, one or more communication interface 114, and one or more input/output (I/O) device 115. The processor 104 may be coupled to and/or linked to (e.g., in electronic communication with) the memory 106, communication interface(s) 114, and/or I/O device(s) 115, for example, that provide (e.g., display, playback, etc.) output information to a user and/or receive (e.g., via keyboard, push-button, touch screen, microphone, etc.) input information from a user.

According to embodiments, the automation server 102 may be configured to perform one or more of the functions, procedures, methods, steps, etc., described in connection with one or more of FIGS. 1-4. Additionally or alternatively, the automation server 102 may include one or more of the structures described in connection with one or more of FIGS. 1-8.

The memory 106 may store instructions and/or data. The processor 104 may access (e.g., read from and/or write to) the memory 106. Examples of instructions and/or data that may be stored by the memory 106 may include instructions 108, which may be interchangeably referred to as automation data controller instructions 108, data 110, which may be interchangeably referred to automation data 110, and/or instructions and/or data for other elements, etc.

The communication interface 114 may enable the automation server 102 to communicate with one or more other devices (e.g., automation controller(s) 116, automation device(s) 122, virtual assistant server(s) 124, which may be interchangeably referred to as voice assistant server(s) 124, and/or one or more other devices). For example, the communication interface 114 may provide an interface for wired and/or wireless communications. According to embodiments, the communication interface(s) 114 may communicate with one or more other devices (e.g., automation controller(s) 116, automation device(s) 122, virtual assistant server(s) 124, etc.) over one or more networks (e.g., the Internet, wide-area network (WAN), local area network (LAN), etc.).

According to embodiments, the communication interface 114 may be coupled to one or more antennas for transmitting and/or receiving radio frequency (RF) signals. For example, the communication interface 114 may enable one or more kinds of wireless (e.g., cellular, wireless local area network (WLAN), personal area network (PAN), etc.) communication. Additionally or alternatively, the communication interface 114 may enable one or more kinds of cable and/or wireline (e.g., Universal Serial Bus (USB), Ethernet, High Definition Multimedia Interface (HDMI), fiber optic cable, etc.) communication.

According to embodiments, multiple communication interfaces 114 may be implemented and/or utilized. For example, one communication interface 114 may be an Ethernet interface, another communication interface 114 may be a universal serial bus (USB) interface, another communication interface 114 may be a wireless local area network (WLAN) interface (e.g., Institute of Electrical and Electronics Engineers (IEEE) 802.11 interface), and another communication interface 114 may be a cellular (e.g., 3G, Long Term Evolution (LTE), Code-Division Multiple Access (CDMA), etc.) communication interface 114.

According to embodiments, the automation server 102 may communicate with one or more automation controllers 116, one or more automation devices 122, one or more virtual assistant servers 124, one or more control devices, one or more virtual assistant device(s) 130, and/or one or more other devices. For example, the automation server 102 may utilize the communication interface(s) 114 to communicate with the one or more automation controllers 116, one or more automation devices 122, one or more control devices, one or more virtual assistant servers 124, and/or one or more other devices (e.g., electronic devices). As described above, one or more of communications may be carried out over one or more networks (e.g., the Internet, WLAN, Zigbee, etc.) and/or over one or more wired and/or wireless links.

Examples of the one or more automation controllers 116 include home controllers, building automation controllers, building automation systems, servers, computers, security systems, network devices, etc. According to embodiments, the automation controller(s) 116 may be located in a building, home, business, vehicle, etc., and/or may be integrated into one or more devices (e.g., vehicles, mobile devices, etc.). One or more of the automation controllers 116 may include a respective processor 118 and memory 120. For example, an automation controller 116 may include executable instructions for controlling one or more automation devices 122 (e.g., local device control instructions, such as local volume control instructions, light activation instructions, media selection instructions, media play instructions, thermostat adjustment instructions, etc.) and/or executable instructions for implementing control commands from the automation server 102.

Additionally or alternatively, an automation controller 116 may include executable instructions for obtaining state data from one or more automation devices 122 (e.g., lock state, door state, security system state, light state, application state, etc.) and/or executable instructions for providing state data to the automation server(s) 102. In some examples, one or more of the automation controllers 116 may include a communication interface to communicate with the automation server(s) 102 and/or the automation device(s) 122. According to embodiments, one or more of communications may be carried out over one or more networks (e.g., the Internet, WLAN, Zigbee, etc.) and/or over one or more wired and/or wireless links. According to embodiments, an automation controller 116 may be integrated into an automation device 122. According to embodiments, an automation device 122 may be integrated into an automation controller 116.

As discussed above, examples of automation devices 122 may include lights, thermostats, appliances (e.g., refrigerators, furnaces, air conditioners, dish washers, laundry washers, laundry dryers), televisions, computers, networking equipment (e.g., routers, modems, switches, etc.), audio/video (NV) receivers, media players, servers, tablet devices, smart phones, sprinkling systems, security systems, locks (e.g., door locks, window locks, etc.), sensors (e.g., door sensors, window sensors, heat sensors, motion sensors, etc.), cameras, speakers, space heaters, game consoles, vehicles, automobiles, aircraft, etc. Each of the automation device(s) 122 may perform one or more functions, such as providing light, dimming, refrigeration, washing, displaying, locking, securing, cleaning, entertainment, etc.

One example of the automation device(s) 122 may be an audio/video receiver that receives audio from the automation controller(s) 116 and/or automation server(s) 102. Another example of the automation device(s) 122 may be a set of lights that may be activated, deactivated, and/or dimmed by the automation controller(s) 116. Another example of the automation device(s) 122 may be a security system that may be armed or disarmed by the automation controller(s) 116. Another example of the automation device(s) 122 may be a television that may be controlled by the automation controller(s) 116 (e.g., the automation controller(s) 116 may command the television to activate, deactivate, switch to a particular channel, to adjust volume, to access media (e.g., a streaming service), etc.).

Another example of the automation device(s) 122 may be an electronic door lock that may be locked or unlocked by the automation controller(s) 116 and/or that may provide a lock state to the automation controller(s) 116 (for user alerts, for example). Another example of the automation device(s) 122 may be a window sensor that provides a state (e.g., opened or closed and/or locked or unlocked) to the automation controller(s) (for user alerts, for example). According to embodiments, one or more of the automation device(s) 122 may correspond to an area. For example, each of the automation device(s) 122 may correspond to a room in a building (e.g., home, business, etc.) and/or to a zone (e.g., zone in a vehicle cabin, zone in an airplane cabin, zone in a showroom, zone in a theater, etc.). For instance, each of the automation device(s) 122 may locally provide lighting and/or audio in an area.

As illustrated in FIG. 1, the automation server(s) 102 may be in communication with one or more virtual assistant servers 124. For example, the automation server(s) 102 may communicate with the virtual assistant server(s) 124 via one or more networks (e.g., Internet, WAN, LAN, etc.). The virtual assistant server(s) 124 may be in communication with one or more virtual assistant devices 130 via one or more networks (e.g., Internet, WAN, LAN, etc.). For example, the virtual assistant server(s) 124 and/or the virtual assistant device(s) 130 may include communication interfaces (not shown in FIG. 1) for wired and/or wireless communication.

According to embodiments, the automation server(s) 102 and/or automation controller(s) 116 may be in communication with a control device (e.g., smart phone, tablet device, control panel, smart television, smart watch, computer, laptop, server, virtual assistant server 124, virtual assistant device 130, etc.) that may provide control information to the automation server(s) 102 and/or automation controller(s) 116. For example, a control device may include a user interface for controlling one or more operations of and/or settings for the automation server(s) 102 and/or automation controller(s) 116. For instance, the control device may include a user interface that captures audio, captures video, and/or presents interactive controls (e.g., sliders, knobs, buttons, number fields, text fields, etc.). The control device may receive input (e.g., audio, touchscreen input, taps, drags, mouse clicks, keypad input, virtual keyboard input, physical keyboard input, camera input, gestures, eye movements, blinks, etc.) associated with one or more operations and/or settings. The control device may send a query to the automation server(s) 102 and/or automation controller(s) 116. The automation server(s) 102 and/or automation controller(s) 116 may utilize the query to perform one or more operations and/or adjust one or more settings. The virtual assistant device(s) 130 may be an example of a control device.

The virtual assistant device(s) 130 may include a processor 132, memory 134, and/or one or more input devices 136. Examples of the input device(s) 136 may include sensors, microphones, cameras, motion sensors, touchscreens, touchpads, buttons, etc. The virtual assistant device(s) 130 may receive input via the input device(s) 136. In some cases, the input may be associated with a user request (for data or for an operation, for instance). One example of a virtual assistant device 130 is a smart speaker that includes a microphone. The microphone captures input sound representing user speech. In other examples, the input device(s) 136 may capture one or more inputs (e.g., touch events, gestures, button presses, keystrokes, etc.) representing user input.

According to embodiments, the virtual assistant device(s) 130 may include and/or may be linked to one or more displays. The display(s) may present visual content (e.g., user interface, images, video, graphics, symbols, characters, etc.). The display(s) may be implemented with one or more display technologies (e.g., liquid crystal display (LCD), organic light-emitting diode (OLED), plasma, cathode ray tube (CRT), etc.). The display(s) may be integrated into the virtual assistant device(s) 130 or may be coupled to the virtual assistant device(s) 130.

According to embodiments, the virtual assistant device(s) 130 may present a user interface on the display(s). For example, the user interface may enable a user to interact with the virtual assistant device(s) 130. For instance, the user interface on the display may present interactive controls (e.g., sliders, knobs, buttons, number fields, text fields, etc.). The virtual assistant device(s) 130 may receive input (e.g., touchscreen input, taps, drags, mouse clicks, keypad input, virtual keyboard input, physical keyboard input, etc.) associated with one or more operations and/or settings. The virtual assistant device(s) 130 may send a signal to the virtual assistant server(s) 124 based on the input. According to embodiments, the display may be a touchscreen that receives input from physical touch (by a finger, stylus, or other tool, for example).

Additionally or alternatively, the virtual assistant device(s) 130 may include or be coupled to another input interface. For example, the virtual assistant device(s) 130 may include a camera and may detect user gestures (e.g., hand gestures, arm gestures, eye tracking, eyelid blink, etc.). In another example, the virtual assistant device(s) 130 may be linked to a mouse and may detect a mouse click. In yet another example, the virtual assistant device(s) 130 may be linked to one or more other controllers (e.g., game controllers, joy sticks, touch pads, motion sensors, etc.) and may detect input from the one or more controllers.

A virtual assistant device 130 may format (e.g., digitize, encode, modulate, etc.) the input and send one or more signals to the virtual assistant server(s) 124 based on the input. A virtual assistant server 124 may include a processor 126 and memory 128. The virtual assistant server 124 may be an electronic device (e.g., web server, computer, etc.) that is configured to interoperate with the virtual assistant device(s) 130. According to embodiments, the virtual assistant server 124 may maintain a record of entities (e.g., automation device(s) 122, groups of automation device(s) 122, rooms, doors, etc.) in memory 128. For example, the record may include identification numbers, names, and/or states for automation device(s) 122, groups of automation devices 122, and/or objects (e.g., doors, rooms, etc.) corresponding to automation device(s) 122.

In some examples, a virtual assistant server 124 may generate a query (e.g., a request for data or for an operation) based on one or more signals from the virtual assistant device(s) 130. According to embodiments, generating a query may include determining an identification number corresponding to an entity name. For instance, a virtual assistant server 124 may receive a signal representing user speech. The virtual assistant server 124 may perform speech recognition based on the signal to produce a query. In other examples, the signal may represent a user input (e.g., tap, touch, click, gesture, etc., from a user interface) corresponding to an operation or request. The virtual assistant server 124 may produce the query based on the signal that represents the user input. The signal may indicate an operation, request, and/or entity name.

In an example, assume that a user addresses a virtual assistant device 130 and says “turn on the living room lights.” The virtual assistant device 130 may capture the user's speech, digitize the speech, and send the speech as a signal to a virtual assistant server 124. The virtual assistant server 124 may perform speech recognition based on the signal and determine that the speech indicates a user request to activate lights in a living room. The virtual assistant server 124 may search the record in memory 128 for an automation device 122 (or group of automation devices 122) with a name “living room lights.” The record may indicate a mapping between the name “living room lights” and an identification number corresponding to an automation device 122 that is a switch for the living room lights. The virtual assistant server 124 may generate a query to activate an automation device 122 with the device identification number, where the query is flagged as a user request. The virtual assistant server 124 may send the query to the automation server 102. The automation server 102 may send the query to the automation controller 116, which may control the automation device 122 (the switch in this example) to activate lights in a living room.

In another example, assume that a user addresses a virtual assistant device 130 and says, “is the front door locked?” The virtual assistant device 130 may capture the user's speech, digitize the speech, and send the speech as a signal to a virtual assistant server 124. The virtual assistant server 124 may perform speech recognition based on the signal and determine that the speech indicates a user request for a state of a front door lock. The virtual assistant server 124 may search the record in memory 128 for an automation device 122 (or group of automation devices 122) with a name “front door lock” or a similar name. The record may indicate a mapping between the name “front door lock” and an identification number corresponding to an automation device 122 that is an electronic lock for a front door.

The virtual assistant server 124 may generate a query to obtain the state of an automation device 122 with the device identification number, where the query is flagged as a user request (and/or as associated with a user request). The virtual assistant server 124 may send the query to the automation server 102. The automation server 102 may send the query to the automation controller 116, which may retrieve the state of the automation device 122 (the front door lock in this example). Upon retrieving the state of the front door lock, the automation controller 116 may send a signal indicating the state to the automation server 102, which may send an indicator to the virtual assistant server 124. The virtual assistant server 124 may record the state and/or send an indicator of the state to the virtual assistant device 130. The virtual assistant device 130 may output synthesized speech from a speaker indicating the state of the front door lock.

The foregoing examples illustrate how a virtual assistant server 124 may obtain and/or maintain a record of automation data corresponding to the automation device(s) 122. As discussed above, the record may compromise the privacy and/or safety of a user. For example, the virtual assistant server(s) 124 may perform machine learning on the automation data in the record to learn patterns in user behavior. These patterns could be utilized for suggesting operations (e.g., “do you want me to turn off the lights?”), marketing, and/or other purposes that may be undesirable for some users. Some configurations of the systems and methods disclosed herein may enable generating artificial automation data to protect actual automation data.

According to embodiments, the memory 106 on the automation server(s) 102 may store automation data controller instructions 108. The processor 104 may execute the automation data controller instructions 108 to obtain automation data 110. Automation data 110 is data that represents the automation device(s) 122. For example, the automation data 110 may include device identifiers (e.g., identification numbers), entity names, and/or states (e.g., state information/data) of the automation device(s) 122. According to embodiments, the automation server(s) 102 may obtain the automation data 110 by requesting and/or receiving automation data from the automation controller(s) 116. For example, the automation server(s) 102 may send one or more requests for one or more device identifiers (e.g., identification numbers), entity names, and/or states of the automation device(s) 122. The automation controller(s) 116 may obtain (e.g., request and/or receive) the automation data from the automation device(s) 122 and/or send the automation data to the automation server(s) 102, which may record the received automation data as actual automation data 110 in memory 106. According to embodiments, the automation data controller instructions 108 may be executed to send the entity names.

State data may be included in and/or may be examples of automation data. State data may be state changes, timings, words, numbers, and/or character strings for automation device(s) 122. State data may be utilized to add noise to a set of state data. According to embodiments, generating the automation data may include generating state data. For example, the automation server(s) 102 may generate state data that indicates states and/or may generate state data with timings of states. For example, if a state of a light is on, the automation server(s) 102 may generate a state indicating that a light is on. In another example, if a television channel state is 5.1, the automation server(s) 102 may the channel state as 5.1.

According to embodiments, the automation data controller instructions 108 may be executed to send the state data proactively. For example, the automation server(s) 102 may send state data indicating state changes to the virtual assistant server(s) 124 when a state change has occurred and/or without a request from the virtual assistant server(s) 124. According to embodiments, the automation data controller instructions 108 may be executed to send the state data in response to a query from the virtual assistant server(s) 124, for example, a query that is not associated with a user request. In a case that the virtual assistant server(s) 124 send a query that is not associated with a user request (e.g., if a query is not flagged as being associated with a user request), for example, the automation server(s) 102 may send the state data in response.

According to embodiments, the automation data controller instructions 108 may be executed to determine that a query from the at least one virtual assistant server 124 is associated with a user request. For example, the automation server(s) 102 may receive a query that is flagged as being associated with a user request. The automation data controller instructions 108 may be executed to send state data in response to determining that the query is associated with the user request. In a case that the query is flagged as being associated with a user request, for example, the automation server(s) 102 may respond by sending actual state data. This may allow a user to obtain state data from the virtual assistant device(s) 130 when a request is made. In some examples, sending state data for queries that are associated with user requests may allow the state data to be provided and/or utilized, for example, from the user's perspective. According to embodiments, one or more of the components or elements described in connection with FIG. 1 may be combined and/or divided. For example, automation data controller instructions 108 may be divided into a number of separate components or elements that perform a subset of the functions associated with the automation data controller instructions 108.

A conventional automation network and/or home network may include one or more voice agents (e.g., voice assistants), for example, which may be associated with respective voice recognition (e.g., voice processing) services. In contrast, according to embodiments, a WHV system may provide one-to-many capabilities between voice input devices (e.g., remote control, cellphone, microphone, etc.) and voice agents (e.g., voice assistant services), for example, to provide whole home interoperability between different (e.g., types) of voice agents.

According to embodiments, in view of automation networks having multiple voice agents, there is a need for centralized coordination of the multiple voice agents, for example, to provide a WHV experience allowing for voice agent interoperability and continuity of service among and/or across (e.g., using) different voice agents.

According to embodiments, for an automation network having more than one (e.g., contemporaneously operating) voice agent, there may be (e.g., simultaneous, concurrent, etc.) control, operation, configuration, etc., of multiple-voice agents (e.g., contemporaneously/concurrently operating) in an automation network. That is, for example, there may be a case where two or more different (e.g., manufacturers, corporations, brands, types, systems, standards, software, etc.) voice agents are deployed in a home automation network. In such a case, for example, for a bedroom, the home automation network may have a first type voice agent (e.g., having a wake word “Butler”) controlling a television and speakers, and a second type voice agent (e.g., having a wake word “Genie”) controlling blinds and light switches and dimmers throughout the home. According to embodiments, in such a case, WHV, which may interchangeably be a system referred to as a WHV system, may provide voice control for an automation network including at least a first type voice agent and a second type voice agent.

According to embodiments, a WHV system may process a voice command (e.g., a user's voiced and/or vocalized input) having voice inputs (e.g., parts of the user's voiced input) for more than one voice agent, for example, that controls more than one electronic device and/or automation network operation. That is, in the above case having voice agents referred to as “Butler” and “Genie”, according to embodiments, a WHV system may receive a user's voice input command (e.g., including a wake word and “start bedtime scene”), and may parse (e.g., process, analyze, compute, etc.) the command for inputs respectively associated with different voice agents, such as first type and second type voice agents.

Further, according to embodiments, any wake word, for example, any of “Butler”, “Genie”, etc., may be used as a wake word by the user. According to embodiments, regardless of the wake word employed (e.g., “Genie” or “Butler”), a WHV system may provide for (e.g., allows for) a voice command “turn on the lights” that may turn on/off the same lights in a current room. According to embodiments, Whole Home Voice (WHV) (e.g., software, hardware, networking, platform, etc., for a WHV system) may include an automation network (e.g., a home/premise automation system) that integrates (e.g., interaction and/or operation of) a variety of vendors and technologies, for example, by having and/or providing (e.g., under the umbrella of) a common user interaction model (e.g., for providing centralized automation and/or control).

As an example, according to embodiments, there may be many kinds of (e.g., electronic) devices in the home listening (e.g., using a microphone) for voice input, and a WHV system may provide for a user being able to turn off their mics with a single button. For example, according to embodiments, based on interactions and/or signaling between elements of a WHV system, such as, between a voice coordinator and a voice input device, a WHV system may receive and/or execute a (e.g., user) command for turning off all mics, wherein the user command may be a single action, input, voice command, etc., that the user inputs to the WHV system.

### Whole Home Voice (WHV) System and Architecture

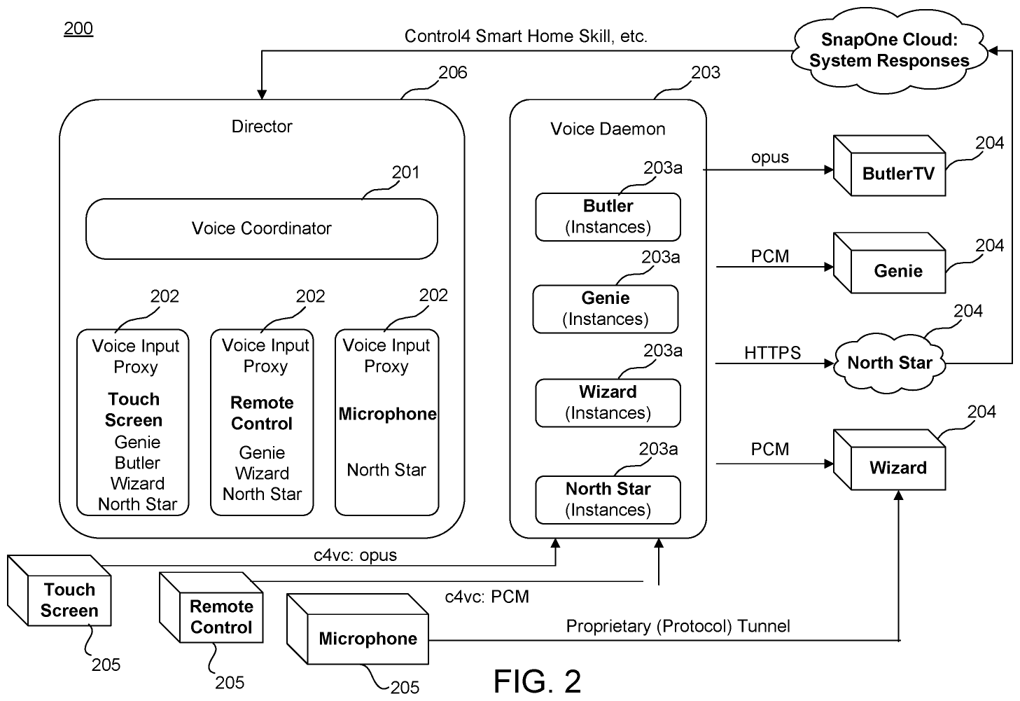

FIG. 2 is a diagram illustrating components and architecture of a WHV system, according to embodiments.

According to embodiments, there may be a (e.g., strong, complete, particular, etc.) distinction between two (e.g., major) aspects of voice services (e.g., voice assistant, voice control, voice recognition, etc.) of an automation system, those two aspects being voice interfaces and system control. For example, according to embodiments, a WHV system 200, which represents (e.g., is an embodiment of) a WHV architecture, may have a (e.g., make a strong) distinction between two (e.g., major) areas of voice control in a network environment (e.g., in a home), the two areas being voice interfaces and system control. According to embodiments, voice interfaces, which may collect voice audio, may (e.g., often) give the user feedback during a conversation, and may route voice audio to a (e.g., an appropriate) consumer, for example, for and/or based on the context.

For example, devices that can collect voice audio are modeled in an automation controller (e.g., an automation network system), such as, for example, the Control4 (C4) system, with a voice input proxy driver. According to embodiments, system control may integrate the C4 system with the smart home aspects of voice. For example, according to embodiments, the C4 implementation of “Genie Smart Home” may be managed via a certain (e.g., Genie) smart home skill in the cloud, and/or a “Genie” driver installed in a C4 system. According to embodiments, WHV may include any of the below discussed components, elements, features, operations, methods, etc. of software and/or hardware.

According to embodiments, WHV system 200 may include any of software and/or hardware for providing any of: (1) audio signal processing, for example echo cancellation and noise suppression; (2) a “Wake Word Engine” (WWE) for recognizing the keyword that starts the processing of audio data; (3) application features to manage the interaction with the user; (4) back-end processes for compute-intensive natural-language processing, decision making and so forth; and (5) application features that route the audio and visual responses appropriately.

According to embodiments, any of entities, elements, devices, items, software, services, features, etc., of a WHV system 200, for example, as shown in FIG. 2, may be embodied (e.g., instantiated, executed, performed, run, etc.) by hardware including any of: (1) a processor running the core application; (2) a digital signal processor (DSP) for (e.g., assisting, computing, helping with, etc.) initial audio processing; (3) a responsive network (e.g., wired and/or wireless internet connection), for example, for processing and performed by (e.g., data deferred to) external servers; (4) microphones and/or microphone arrays; (6) one or more speakers for audio response playback; and (6) lights and/or display devices for visual responses. However, the disclosure is not limited to the above noted software and/or hardware.

According to embodiments, the above noted hardware and/or software may be grouped into any of the following categories/types: (1) input: collection of real-time voice data; (2) voice targets: consumers of voice audio, for example, a cloud-based voice agent (such as Genie or Butler), or a set-top box, such as an Internet Protocol (IP) video device, or a cable/fiber TV modem; (3) feedback: immediate and interactive visual and audio indicators that help the user navigate the voice interface process; (4) processing: voice parsing, domain mapping, decision making, command response and so forth; and (5) any of responses: voice output, control events, and payloads, such as music playback. However, the disclosure is not limited to the above noted categories.

According to embodiments, a Control 4 (C4) voice control (VC) protocol, which may also be referred to as the C4VC protocol may be used by (e.g., may define procedures, signaling, messages, etc. used by) a device having a microphone (e.g., a C4 microphone enabled device) to push (e.g., provide, communicate, signal, etc.) a voice control audio stream, for example, to other devices, entities, programs, software components, etc. The C4VC protocol is an example a audio (e.g., voice) control protocol, for example, that operates at an application layer (e.g., is part of an/or is an application), for example, to provide any of raw and/or compressed digital audio signals and/or any of information associated with digital audio signals, such as audio data format, audio (e.g., source/destination) device, encoder/decoder information, versioning, sample rate, etc. For example, such audio control protocols may include PCM, opus, mp3, ogg vorbis, HTTPS, or any other format, system and/or protocol, for transmitting audio data, for example using data packets and/or communication networks.

According to embodiments, a WHV system 200 may include any one or more of the elements illustrated in FIG. 2. According to embodiments, in a case of multi-voice agent control, for example referring to FIG. 2, there may be any of a voice coordinator 201, a voice input proxy 202 (e.g., a proxy 202 for a voice input device), an audio daemon 203, which may be interchangeably referred to as a voice daemon 203 (and/or any of voice daemon instances 203a) hereinbelow, any number of voice targets 204 (e.g., input-bound voice targets 204, voice target driver API, etc.), an automation controller 206 (which may also be referred to as director 206, for example, as an agent/component of automation controller 206 software for controlling and/or operating an automation network), and voice input devices 205, for performing, providing, executing, facilitating, etc., any of the operations, features, elements, methods, steps, signals, conditions, determinations, etc., as described hereinbelow. According to embodiments, a voice daemon 203 may be for (e.g., may perform, execute, etc.) any of the following: transcoding audio data, routing data to services (e.g., voice targets, voice assistant services, etc.), and managing software development kits (SDKs) and/or drivers associated with the services.

According to embodiments, a voice coordinator 201 may be provided according to a system, network, and/or architecture of an automation system, for audio and/or voice control services. According to embodiments, voice control services (e.g., features, software, applications, etc.) may be provided according to (and/or by) a variety of different software, networks, manufacturers, systems, protocols, technologies, devices, services, operating systems, etc. According to embodiments, a voice coordinator 201 may discover (e.g., may be responsible for discovering) voice-enabled components of a (e.g., automation network) system. According to embodiments, a voice coordinator 201 may configure (e.g., voice-enabled) components, for example, for runtime use. According to embodiments, a voice coordinator 201 may provide, determine, manage, discover, configure, etc., any number of pathways, connections, channels, signal flows, etc., used to provide voice control services.

For example, a voice coordinator 201 may provide/manage pathways for a voice input device 205 (e.g., microphone, remote control with microphone, etc.) to be used to control any number of different devices using any number of different voice agents. According to embodiments, for example, as discussed hereinbelow, a voice coordinator 201 may be a software agent of an automation system operating an automation network, for example such as a director agent for controlling a C4 automation system, for example, that is a software entity composed/created using a programming language, such a Lua, or any other similar programming language. However, the disclosure is not limited thereto, and the voice coordinator 201 may be any software, agent, entity, instantiation, etc., that is similar and/or suitable for the voice coordinator 201 as disclosed herein.

According to embodiments, a voice coordinator 201 may configure voice-input devices 205. For example, according to embodiments, a voice coordinator 201 may assign voice target configurations that a (e.g., particular) device may support (e.g., has the capability of supporting). According to embodiments, a voice coordinator 201 may assist with (e.g., device, voice agent, software, end user, etc.) registration, for example, by performing (e.g., applicable, associated, etc.) registration chores. According to embodiments, a voice coordinator 201 may broadcast feedback events, for example, including events associated with registration, device state/status, device type, user type, device context, user context, etc.

According to embodiments, a voice coordinator 201 may manage responses, for example according to feedback events. For example, according to embodiments, a voice coordinator 201 may route a reply to a voice request to any of a device being interacted with and a (e.g., room's audio/video) endpoint (e.g., a device producing/providing audio/video output). According to embodiments, a voice coordinator 201 may manage a voice daemon 203. For example, according to embodiments, a voice coordinator 201 may create any number of instances of services (e.g., voice daemon instances 203a). In a case of creating/instantiating a voice service, a voice coordinator 201 may map the service to voice inputs. According to embodiments, a voice coordinator 201 may, for example, by design, not process (e.g., consume, encode/decode, compute, deal with, etc.) voice audio data.

According to embodiments, a proxy 202, which may be referred to as a voice input proxy 202, may collect voice audio data, for example, for consumption by the voice daemon 203. According to embodiments, a voice input proxy 202 may be modeled using a programming language entity/program (e.g., a C++ Proxy Driver), but is not limited thereto. According to embodiments, a voice input proxy 202 may maintain (e.g., potentially) many voice target configurations per single input device 205. According to embodiments, a (e.g., concept, conception, etc.) of a device's “current voice target” and a “current room” may be supported by a voice input proxy 202. According to embodiments, a voice input proxy 202 may manage a device's microphone(s)—on or off. According to embodiments, a voice input proxy 202 may manage other exposed Variables, for example, which may be subscribed to by a navigation tool/entity (e.g., a graphical UI, a navigator, a browser, etc.), and whose (e.g., displayed) content may depend on the (e.g., current) voice target 204.

According to embodiments, a (e.g., stand-alone) daemon 203 may provide voice-agent services, and for example, may be referred to as a voice daemon 203. According to embodiments, a voice daemon 203 may run on any (e.g., existing, upcoming, future, not yet implemented, etc.) home controller or other controller device (e.g., a C4 controller). For example, such controllers may be managed according to a system management (e.g., sysman). According to embodiments, a voice daemon 203 may spawn and manage (e.g., separate) processes, for example, for various types of “services” (“ButlerTV”, “Genie”, “Wizard”, etc.). According to embodiments, in a case of a (e.g., home/premise) device control/automation system (e.g., a C4 system having a home controller on premise or off premise), a voice daemon 203 may expect incoming voice audio data to use the C4VC protocol. According to embodiments, other protocols may be used by any of a C4 controller and other systems (e.g., used by and/or interacting with the C4 controller). According to embodiments, a voice daemon 203 may support complex services, such as an instance/instantiation of an SDK (e.g., WIZARD Device SDK), or simple “pass-through” services, such as for ButlerTV.

According to embodiments, in a case of multi-voice agent control, for example, to provide whole home voice (WHV) services/features, voice targets 204 may be provided, and may be referred to as a WHV voice target 204. According to embodiments, a WHV voice target 204 may be (e.g., referred to as, represented by, considered to be, etc.) a driver in a control system (e.g., a Control4 home automation/control system). According to embodiments, a WHV voice target 204 may receive voice audio commands (e.g., that originate from a user, or any similar and/or suitable source for audio commands). According to embodiments, a WHV voice target 204 may perform any of operations, methods, procedures, programs, automations, instantiations, executions, commands, responses, etc., in response to a (e.g., received) voice audio command. According to embodiments, a WHV voice target 204 may be modeled according to voice daemon service instances. For example, a WHV voice target 204 may be modeled one-to-one with a voice daemon service instance. However, this disclosure is not limited thereto, and one or more (e.g., WHV) voice targets 204 may be modeled as any of one-to-many, many-to-one, or many-to-many, with respect to voice daemon service instances.

According to embodiments, a WHV voice target 204 may be modeled as (e.g., respective to) any one or more of an BulterTV device, a Wizard SDK instance (e.g., instantiation), or any other similar and or suitable device, entity, component, agent, etc., that may receive an audio voice command. According to embodiments, a WHV voice target 204 may have (e.g., may be characterized by) a type, which may be referred to as a target type, a (e.g., WHV) voice target type, etc. According to embodiments, a voice target type may support a feature (e.g., a concept) associated with any of a context, context information, heuristics, heuristic information, etc., any of which may be implicit or explicit (e.g., an explicit context, implicit heuristic information, etc.). For example, a voice target 204 may have a target type for (e.g., supporting a concept of) an implicit (i.e., or explicit) “room context”, and in such a case, such target type may allow for (e.g., enable) commands such as “turn on the lights”, “close the blinds”, “raise temperature to . . . ”, etc.

According to embodiments, a voice target 204 may be bound (e.g., associated with, tied to, mapped to, exclusively for, etc.) to an input (e.g., an input device, an input type, an input location, etc.). In a case of being bound to an input, such voice target 204 may be referred to as an input-bound voice target 204, and/or a voice target type of such voice target 204 may be referred to as an input-bound target type. According to embodiments, in a case where a voice target 204 is bound to an input (e.g., is an input-bound voice target type), a voice coordinator 201 may (e.g., start) match voice daemon service instances to a voice input instance for audio input. Further, in such a case, the voice coordinator 201 may (e.g., permanently, temporarily, for some duration, according to conditions/context) bind (e.g., matched) voice daemon service instances to respective Voice input instances, for example, to allow for audio input from/by a user.

According to embodiments, matching and/or binding of voice daemon service instances to Voice input instances may allow for an (e.g., input bound) voice target 204 (and/or voice target technology, such as Genie, Wizard, Butler, etc.) to model different devices (e.g., audio input device, controlled device, etc.) while performing operations and/or responding to a user's voice input (e.g., a voice target 204 conversing or “in conversation” with a user). For example, according to embodiments, a voice target technology, such as Genie, and/or an instance/instantiation of a voice target 204, may select (e.g., determine, choose, configure, etc.) a device (e.g., the device that is closest to the user) for displaying information (e.g., feedback) to the user during a conversation with the user. According to embodiments, in such a case of a voice target technology selecting a device for use during conversation with the user, a voice target 204 may be (e.g., always) available (e.g., mapped, bound, associated) to that Voice input device 205.

According to embodiments, in a case of a Voice coordinator 201 performing matching regarding (e.g., for, associating, binding, etc.) an input-bound voice target type, the Voice coordinator 201 may delay (e.g., wait, stall, pause, suspend, hold, etc.) matching the voice daemon service instance. That is, there may be a case of a Voice coordinator 201 discovering (e.g., any number of) voice inputs and determining (e.g., receiving information indicating) that one or more targets 204 are not enabled (e.g., are disabled, a flag/bit/information indicates a target 204 is not enabled, TARGET_ENABLED=false for a target 204, etc.). In such a case, the Voice coordinator 201 may delay matching the voice daemon service instance to a voice target 204. According to embodiments, the Voice coordinator 201 may delay the matching, because in a case where initially TARGET_ENABLED=false and such variable changes (i.e., changes to TARGET_ENABLED=true) while variable REGISTERED indicates no registration (i.e., REGISTERED=false), there may be (i.e., this may indicate and/or precipitate) a registration process that involves the (end) user.

Further, according to embodiments, in a case where TARGET_ENABLED=false for a voice target 204, the Voice coordinator 201 may not (e.g., does not, should not, will not, must not, etc.) delay starting (i.e., wait to start) the (e.g., voice) service instance for one or more target types. That is, according to embodiments, in a case where a voice target 204 is not an input-bound voice target type, such voice target 204 may be for (e.g., simply, only, focused, exclusively, etc.) controlling a (e.g., specific, certain, etc.) device, and a Voice coordinator 201 may match (e.g., start matching, generate,) a voice daemon service instance to the voice target 204, but not bind the voice target 204 to a (e.g., particular) Voice input. In such a case of not binding a voice target 204, according to embodiments, the voice target 204 may be bound to (e.g., any number of) different Voice input devices 205, such as, for example, multiple remote controllers (e.g., remotes having transceivers for any of IR, WiFi, Bluetooth, etc.) in different rooms controlling a same device (e.g., the same ButlerTV device).

According to embodiments, any of a time, a context, a condition, etc., at which a Voice input device 205 may be bound to a voice target 204 may vary according to any of a system operation, a system configuration, a user configuration, an automation configuration, etc. For example, according to embodiments, a C4 system (e.g., a C4 operating system (OS), a device executing a C4OS, etc.) may determine a time (e.g., and/or condition, context, etc.) at which a Voice input is bound to a voice target 204. According to embodiments, for example, in a case where a (e.g., selected) media device voice target 204 is in a room that has a Voice input, the Voice input may be bound to that target 204, for example, by providing the voice input with the target's 204 VOICE_INPUT_CONFIG. According to embodiments, in such a case (i.e., in such a state), the voice target 204 may support an (e.g., implicit) device context, for example, to enable commands that omit specifying the device, such as “Play Ted Lasso”. According to embodiments, in a case where binding has occurred, a voice target 204 may be (e.g., only) available to that Voice input device 205 after the target 204 has been bound.

According to embodiments, there may be an application programming interface (API) for a driver associated with a voice target (e.g., a voice assistant service). According to embodiments, a voice target driver API may (e.g., should, must, etc.) support any of the following routines, signaling, interfacing, etc.:
(1) The driver must declare a capability of “voice_target”=<String>, for example “Wizard”, “comcast”, “ButlerTV”, etc. The driver must declare a capability of “voice daemon_service”=<String>, for example “Wizard”, “pcm_connect”, etc.; GET_VOICE_TARGET_CONFIG: returns a <String> specifying to Voice Coordinator data required to create a matching voice daemon service instance. For example, it might be a URI specifying how to communicate with the actual audio data destination;
(2) As well, if the eventually destination can accept voice audio commands via a simple “connect-send-disconnect” protocol, it can provide the raw audio encoding (using the GStreamer-style specification) with this call: GET_VOICE_ENCODING; and
(3) If the voice target will not be using a C4 director agent to control devices, it may support the following calls:
   a. ON_VOICE_COMMAND;
   b. ON_FEEDBACK_STATE_CHANGED; and
   c. ON_RESPONSE_DATA_CHANGED.

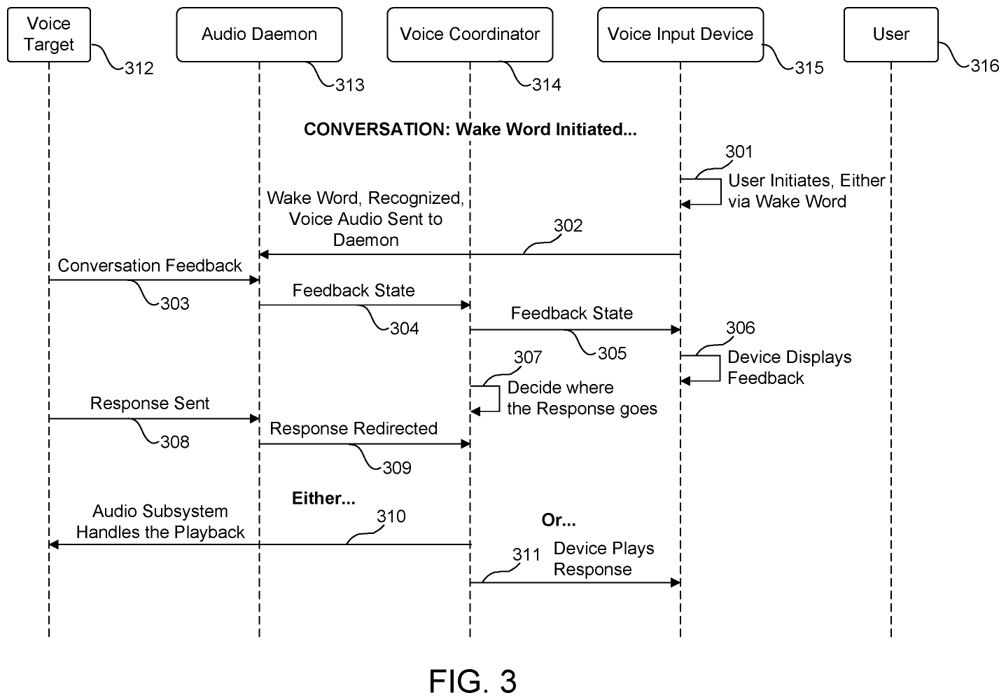

FIG. 3 is a diagram illustrating a signal flow for whole home voice (WHV) services, according to embodiments.

Referring to FIG. 3, a WHV system (e.g., service) for providing voice services for any number of (e.g., different or duplicate) voice agents (e.g., Genie, Butler, Wizard, etc.) may operate according to any one or more of the following operations and/or procedures. According to embodiments, a first operation 301 may be a voice input device (e.g., a remote control device, a speaker with a microphone, a stand-alone microphone, a cell phone, a tablet, a PC, etc.) 315 receiving a voice input (e.g., a command, a question, a request, etc.) from a user 316. For example, a user 316 may say “Genie, tell me a joke”. According to embodiments, a second operation 302 may be an audio daemon 313 (e.g. a voice daemon 313) receiving (e.g., from the voice input device 315) any of a (e.g., recognized) wake word, a voice input, voice audio, etc.

According to embodiments, a third operation 303 (e.g., which may be optional) may be receiving, for example, by the audio daemon 313 from a voice target 312, (e.g., conversation) feedback associated with the voice target 312. According to embodiments, the feedback may indicate (e.g., may be used to determine) a state (e.g., idle, listening, processing, speaking, etc.) and/or state information of the voice target 312. According to embodiment, a fourth operation 304 may be providing the state information to the voice coordinator 314, which, as a fifth operation 305, may forward (e.g., send) the feedback state information to the voice input device 315. According to embodiments, in a case of the voice input device 315 receiving the state information, as a sixth operation 306, the feedback (e.g., the information regarding the state and/or status of the voice target 312) may be provided (e.g., outputted, displayed, voiced, played back) to a user 316a.

According to embodiments, a seventh operation 307 may be the voice coordinator 314 determining, updating, revising, etc., mapping information and/or sending (e.g., broadcasting, multi-casting, distributing, providing, returning, etc.) the (e.g., revised, updated, etc.) mapping information. However, the present disclosure is not limited thereto, and according to embodiments, any of the elements, steps, features, etc., of the seventh operation 307 may be performed at any time. For example, according to embodiments, the mapping information may be determined (e.g., based on registration information, polling information, configuration information, etc.) at any time, for example such as at regular time intervals, based on a trigger, etc., and the (e.g., current) mapping information may be provided to any of the elements of the WHV system at the time of determining the mapping information or at any other time.

According to embodiments, an eighth operation 308 may be a voice target 312 providing (e.g., sending) a response, for example to an audio daemon 313. According to embodiments, as a ninth operation 309, the audio daemon 313 may redirect the response (e.g., based on updated mapping information) to the voice coordinator 304. According to embodiments, any of the following may occur: (1) a ninth operation 310 for an audio subsystem handles (e.g., provides playback of) the response information to a user; and (2) an eleventh operation 311 of a device (e.g., having a video subsystem) outputting the feedback (e.g., the response) information to a user.

According to embodiments, a WHV system (e.g., entity, service, provider, etc.) may provide registration, for example, via/using a user interface (UI), such as a navigator and/or any other similar and/or suitable tool (e.g., software, UI, application, etc.) for configuring and/or controlling automation networks. According to embodiments, voice targets, such as WIZARD, Butler or North Star, may require registration and/or authorization steps as part of their initial configuration. For example, such registration/authorization may (e.g., often) include requesting credentials from the end user. For example, in a case of WIZARD, a user logs on to the Wizard account with which Genie will be associated in a home.

According to embodiments, in such a case, a navigator and/or a voice coordinator may (e.g., then) take care of the (e.g., necessary) steps to set up a voice daemon and voice input devices, for example, that are involved in providing WHV. According to embodiments, in a case where registration involves the given voice target for all Voice Inputs that aren't registered, (e.g., only) one voice target type may undergo the registration process, for example, at a time/instance.

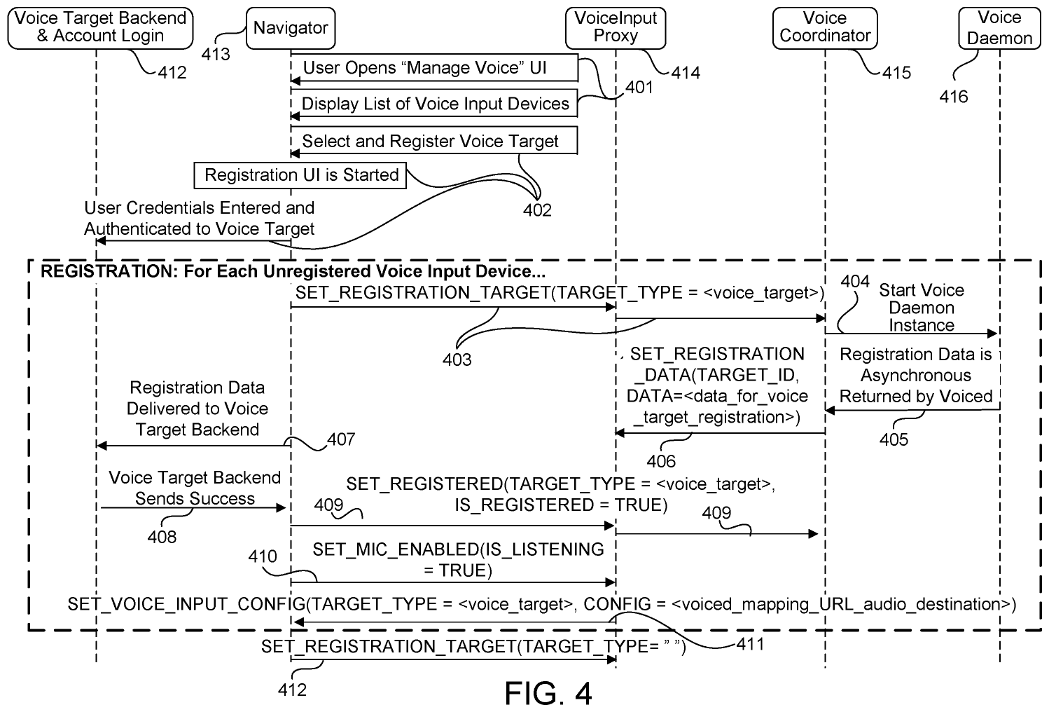

FIG. 4 is a diagram illustrating voice target registration for whole home voice (WHV) services, according to embodiments.

According to embodiments, for example, referring to FIG. 4, as a first operation 401, a user interface (UI) associated with a WHV service, for example, a UI referred to as a Manage WHV UI for managing (e.g., configuring) the WHV service of an automation network may be initiated. That is, according to embodiments, a user may initiate (e.g., start, instantiate, execute, run, open, display, etc.) the Manage WHV UI (e.g., using a navigator, a web browser, an operating system, etc., for displaying the UI), to allow for (e.g., provide, enable, etc.) managing (e.g., configuring) the WHV service of an automation network. Further, according to embodiments, upon initiation, the Manage WHV UI may display a list of (e.g., available, configurable, registered, unregistered, etc.) electronic devices that include voice input capabilities, which may be referred to as voice input devices.

According to embodiments, for example, referring to FIG. 4, as a second operation 402, one or more voice targets 412, for example, from among those displayed by the Manage WHV UI, may be any of selected and/or registered. That is, according to embodiments, a user of the Manage WHV UI may select any of the (e.g., displayed) voice targets (e.g., “Butler”, “Genie”, etc.) and/or the user may register (e.g., the selected) voice targets, for example, by pressing a “register” button of the Manage WHV UI. According to embodiments, for registration of voice targets (e.g., by selecting the “register” button), a UI for (e.g., appropriate for, specific to, particular to, allowing for, etc.) registration of the voice target may be displayed (e.g., by the Manage WHV UI), for example, allowing for (e.g., providing for, enabling, etc.) input of credentials (e.g., user ID, password, address, URL, etc.) for any of authentication and/or completion of registration. That is, according to embodiments, the Manage WHV UI may display a (e.g., separate, unique, particular, etc.) UI for each of the selected voice targets, for example, in separate and/or sequentially displayed UIs.

Alternatively, according to embodiments, the Manage WHV UI may display a single UI having multiple (e.g., respective) areas for inputting credentials (e.g., respectively) associated with each of the selected voice targets. According to embodiments, for example, as part of the second operation, a user of the Manage WHV UI may input (e.g., enter, type, etc.) credentials for each of the selected voice targets. According to embodiments, the credentials (e.g., as inputted by the user) may be to an entity (e.g., software and/or hardware executing software) responsible for (e.g., providing, executing, performing, etc.) user registration and/or authentication for the voice target, such as a voice target account login entity.

According to embodiments, the below described operations (e.g., third operation 403 through twelfth operation 412) may be performed for each unregistered voice input device (e.g., for each voice input device that is not registered with a voice target). According to embodiments, for example, as a third operation 403, for registration of an unregistered voice input device, the Manage WHV UI may send a first message including information associated with (e.g., indicating) a target type, for example for identifying (e.g., indicating) a registration target (e.g., that is to be set and/or configured). For example, according to embodiments, the first message for setting a registration may be identified as SET_REGISTRATION_DATA, and may include information indicating a target type as a (e.g., particular, certain, etc.) voice target 412, wherein the included information is indicated as TARGET_TYPE=<voice_target>. For the third operation 403, according to embodiments, the first message may be provided to (e.g., transmitted to, communicated to, returned to, etc.) a voice coordinator, for example, by a transceiver of the device providing (e.g., displaying) the Manage WHV UI to the user.

According to embodiments, for example, as a fourth operation 404, a voice daemon instance of the voice daemon entity 416 may be instantiated (e.g., generated, started, created, executed, etc.), for example, by the voice coordinator 415. For example, according to embodiments, the voice coordinator 415 may transmit a second message to a voice daemon entity 416, wherein the message instructs (e.g., includes information instructing) the voice daemon entity 416 to instantiate a voice daemon instance associated with the indicated voice target. According to embodiments, for example, as a fifth operation 405, the voice daemon entity 416 may transmit a third message for indicating status of registration data to be any asynchronous, synchronous, incomplete, complete, online, offline, active, inactive, may be transmitted, for example, by any of the instantiated voice daemon and/or the voice daemon entity 416 to the voice coordinator 415.

According to embodiments, for example, as a sixth operation 406, a fourth message for setting registration data may be provided (e.g., transmitted, sent, returned, etc.) from and/or by the voice coordinator 415 to a voice input proxy 414. According to embodiments, the fourth message may be indicated as SET_REGISTRATION_DATA and may include any of information associated with an identifier (ID) of a voice target (e.g., a voice target ID) indicated as TARGET_ID, and information indicating information about a data type. For example, according to embodiments, a data type may include information indicating data to be for voice target registration, and, for example, such data may be indicated as and or to be data for voice target registration.

According to embodiments, for example, referring to FIG. 4, as a seventh operation 407, a fifth message, for providing (e.g., informing, delivering, sending, transmitting, etc.) registration data to a voice target backend 405, that is, the voice target account login entity 405, by device hosting the navigator 413 displaying Manage WHV UI. According to embodiments, for example, as an eight operation 408, the voice target backend 405 may transmit a sixth message for indicating success to the navigator 413, for example, in response to receiving the registration data of the seventh operation 407 from the navigator 413.

According to embodiments, for example, as a ninth operation 409, a seventh message for indicating whether a voice target is registered may be provided, for example, by the navigator 404 transmitting a SET_REGISTERED message including information indicating whether a voice target is registered. According to embodiments, the SET_REGISTERED message may be provided to the voice coordinator 415, and may include any of: information identifying a voice target, and information indicating whether the voice target is registered.

According to embodiments, for example, as a tenth operation 410, an eighth message for enabling voice input devices (e.g., microphones) may be provided. According to embodiments, the eighth message may be provided by the navigator 413 to the voice input proxy 414. According to embodiments, the eighth message may include information indicating whether a microphone is active (e.g., is to be listening and/or activated, is to be configured as listening and/or active, etc.), for example, as a SET_MIC_ENABLED message indicating whether listening is true.

According to embodiments, for example, as an eleventh operation 411, a voice input may be configured, for example for mapping voice inputs to voice targets. According to embodiments, the eleventh operation 411 may include providing a ninth message for setting a voice input configuration, for example, the ninth message being indicated as SET_VOICE_INPUT_CONFIG. According to embodiments, the ninth message may include information indicating a target type, for example a target type being a voice target such as “GENIE”, “BUTLER”, etc., and configuration information, for example, indicated as “CONFIG”. According to embodiments, the configuration information may be mapping information, for example mapping voice inputs to URLs associated with the voice target. According to embodiments, the ninth message may be provided by the voice coordinator 401 to the voice input proxy 402.

According to embodiments, for example, as a twelfth operation 412, a registration target may be set. For example, according to embodiments, the twelfth operation may include sending a tenth message for setting a registration target, the tenth message indicated as SET_REGISTRATION_TARGET. According to embodiment the tenth message may include information indicating a target type and/or indicating the target.

According to embodiments, for example, referring to operations of FIG. 4, there may be a case where software variables (e.g., C4 director variables), such as REGISTERED, may be target-specific and may be referencing a voice target that is not the REGISTRATION_TARGET. According to embodiments, in such a case, there may be no (e.g., need be no, should be no, cannot be, etc.) behaviour during registration that depends on the values of target-specific variables. That is, according to embodiments, all commands may be “SET” Commands, which may reference a (e.g., current) REGISTRATION_TARGET.

According to embodiments, for example, referring to operations of FIG. 4, there may be a case of (e.g., software) identifiers (e.g., IDs) being any of: (1) “Device ID”, also called the “Protocol Driver ID”, wherein (e.g., C4) DeviceID identifies a protocol driver instance for a device, stable for the life of the instance, and which may be visible to a user of a UI; (2) “VoiceInput ID”, which may be a (e.g., C4) DeviceID of a voice input proxy driver instance for a device, stable for the life of the instance; (3) a “Voice Target ID” and/or “Voice Target Key”, which may be a (e.g., C4) DeviceID of a media device protocol driver accepting voice input and supporting a driver command GET_VOICE_TARGET_CONFIG; (3) “Mapping ID”, which may also be referred to as a “Voice Daemon ID”, which may be an “external ID” of a voice daemon service instance, and which may change at arbitrary times, or in other words a voice daemon may “remap” voice daemon instances at will. The mapping ID for a service instance may be discovered by any of: (a) a voice configurator “Query Status” button; and (b) a command on the controller running voice daemon; and (4) a “XXid” which may be an opaque string identifying devices in a subsystem of an automation network.

While examples of arrangements of devices for performing some examples of the techniques are described herein are given in relation to the Figures, other arrangements may be utilized in some examples. As used herein, the term “couple” and other variations thereof (e.g., “coupled,” “coupling,” etc.) may mean that one element is connected to another element directly or indirectly. For example, if a first element is coupled to a second element, the first element may be connected directly to the second element (without any intervening element, for example) or may be connected to the second element through one or more other elements. A line(s) in one or more of the Figures (e.g., in the block diagrams) may indicate a coupling(s) and/or communication link(s). A coupling may be accomplished with one or more conductors (e.g., one or more wires). A communication link may be established with a wired link and/or wireless link. For instance, elements may communicate over a wired and/or wireless network (e.g., Ethernet network, Wi-Fi network, mesh network, Zigbee network, local area network (LAN), personal area network (PAN), wide area network (WAN), the Internet, etc.).

Various configurations are now described with reference to the figures, where like reference numbers may indicate functionally similar elements. The systems and methods as generally described and illustrated in the figures herein could be arranged and designed in a wide variety of different configurations. Thus, the following more detailed description of several configurations, as represented in the Figures, is not intended to limit scope, as claimed, but is merely representative of the systems and methods. As used herein, the term “plurality” may indicate two or more. For example, a plurality of components may refer to two or more components.

As used herein, the term “circuit,” “circuitry” or variations thereof may refer to one or more electronic and/or electrical circuits. In some examples, a circuit may include one or more discrete components such as one or more resistors, capacitors, inductors, transformers, transistors, etc. Examples of circuitry may include dimming circuitry, a processor, an image sensor, etc. In some examples, circuitry may be included in an electronic device. In some configurations, an electronic device may be housed within a wall box.

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The term “computer-readable medium” refers to any available medium that can be accessed by a computer or processor. A computer-readable medium may be non-transitory and tangible. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the systems, methods, and apparatus described herein without departing from the scope of the claims.

1. A whole home voice (WHV) system of an automation network connecting an automation server, an automation controller, and any number of automation devices, the WHV system comprising:
any number of voice input devices for receiving voice inputs vocalized by a user of the automation network; and
an automation controller for executing any of: (1) a voice coordinator for coordinating WHV system operations, (2) any number of voice input proxies for proxying for the voice input devices; and (2) a voice daemon executing any number of voice daemon instances each respectively associated with one of any number of voice targets,
wherein the automation controller is communicatively connected to the voice targets.

2. The WHV system of claim 1, wherein the voice targets are associated with respective voice assistant services.

3. The WHV system of claim 1, wherein the voice input devices are any of: a touchscreen, a home speaker, a stand-alone microphone, a remote control, a television, a home appliance, an intercom device, a cell phone, a computer, and a personal electronic device.

4. The WHV system of claim 1, wherein the voice coordinator determines mapping information for mapping any of the voice input devices to any of the voice targets.

5. The WHV system of claim 4, wherein the mapping information is determined according to any of device registration information and device polling information.

6. The WHV system of claim 1, wherein the received voice inputs are recordings of sounds or speech vocalized by a user of the automation network.

7. An automation controller having any of a processor, a memory, and a communication interface, the automation controller configured to:
determine mapping information mapping any number of voice input devices to any number of voice targets;
broadcast the mapping information to any number of devices communicatively connected to the automation controller via an automation network;
transmit a message commanding a voice daemon to instantiate a voice daemon instance for each of the voice targets included in the mapping information;
instantiate a respective voice input proxy for each of the voice input devices; and
instruct the voice daemon to transmit user voice inputs according to the mapping information.

8. The automation controller of claim 7, wherein the voice targets are associated with respective voice assistant services.

9. The automation controller of claim 7, wherein the voice input devices are any of: a touchscreen, a home speaker, a stand-alone microphone, a remote control, a television, a home appliance, an intercom device, a cell phone, a computer, and a personal electronic device.

10. The automation controller of claim 7, wherein the mapping information is determined by mapping any one or more of the voice input devices to any one or more of the voice targets.

11. The automation controller of claim 10, wherein the mapping information is determined according to any of device registration information and device polling information.
